(19) United States
(12) Patent Application Publication
(10) Pub. No.: US 2013/0273232 A1
(43) Pub. Date: Oct. 17, 2013

(54) CEREAL FOOD AND PRODUCTION METHOD THEREOF

(71) Applicant: Hiroyuki Mitobe, Koshigaya-shi (JP)

(72) Inventor: Hiroyuki Mitobe, Koshigaya-shi (JP)

(73) Assignee: Kao Corporation, Chuo-ku (JP)

(21) Appl. No.: 13/825,217

(22) PCT Filed: Sep. 20, 2011
(86) PCT No.: PCT/JP11/71330

§ 371 Date: Jun. 24, 2013

(30) Foreign Application Priority Data
Sep. 21, 2010 (JP) 2010-210900

(51) Int. Cl. A23L 1/30

(52) U.S. Cl. CPC A23L 1/3002
USPC 426/618

(57) ABSTRACT

A method of producing a cereal food containing catechins in an amount of 0.1 mass % or more with respect to the dry mass of the cereal food, the method including spraying an aqueous solution of a purified preparation of a catechins-containing plant extract after forming a cereal food, the purified preparation of a catechins-containing plant extract having a turbidity of 30 FTU (formazin) or less at an aqueous solution of 0.5% solid content.

### FIELD OF THE INVENTION

The present invention relates to a cereal food containing catechins and a production method thereof.

### BACKGROUND OF THE INVENTION

It is known that catechins have physiological functions such as α-amylase activity inhibitory function and cholesterol absorption inhibitory function, in addition to their well-known function as antioxidants (see Patent Literatures 1 and 2), and incorporation of catechins into various foods has been studied in recent years. Since catechins are added to foods, catechins derived from plants such as teas, grapes, apples and soybeans are widely used.

A cereal food blended with powdered green tea has been marketed as a cereal food containing catechins. Blending in powdered green tea can impart tea flavor as well as incorporate catechins. Furthermore, a cereal bar containing a trace amount of crude catechins together with vitamins A and E for imparting a function of preventing oxidation is also known (see Patent Literature 3).

When catechins are used as antioxidants, the purpose is achieved by blending a crude catechin preparation into a cereal food in an amount of 0.1 to 0.2 mass %.

### CITATION LIST

### Patent Literatures

Patent Literature 1: JP-A-60-156614 (“JP-A” means unexamined published Japanese patent application)

Patent Literature 2: JP-A-3-133928

Patent Literature 3: EP 1844664 A1

### SUMMARY OF THE INVENTION

In order for catechins to effectively exert a physiological effect upon ingestion of a food containing the catechins, it is necessary to incorporate the catechins in the food at such a concentration that an amount effective for achieving the intended physiological effect is established relative to the amount of the food ingested.

A conceivable method for incorporating catechins into the cereal food is to knead the catechins into a dough during the production of the cereal food. However, when using powdered green tea, which is a solid powder obtained by finely grinding tea leaves, as a raw material of catechins, the content of the catechins in the powdered green tea is around 10 mass %. The amount of the powdered green tea blended into the cereal food therefore becomes 10 times higher than that necessary to establish the required amount of catechins. Furthermore, when a commercially available catechin preparation obtained by extraction from tea leaves and drying is used as a raw material for catechins, the concentration of the catechins in the catechin preparation is only about from 30 to 40%. The preparation therefore needs to be blended in an amount several times higher than the required amount of catechins incorporation.

The present inventor found that in the baking process during the production of a cereal food, the content of catechins decreases due to the exposure of the catechins to high temperature and high pressure, even though a large amount of a catechin preparation is kneaded into a dough.

In order to avoid the exposure of the catechins to the above-mentioned baking process, the inventor tried to incorporate the catechins in the cereal food by spraying an aqueous solution of the catechin preparation on a formed cereal food. However, when the sprayed amount was increased so as to increase the incorporated amount of the catechins, the formed cereal food became swollen and its shape could not be retained, and it aggregated after drying. Thus, in order to incorporate the catechins in the cereal food in a higher amount, it was necessary to spray a small amount of an aqueous solution containing a catechin preparation at high concentrations. However, when it was attempted to prepare an aqueous solution of a catechin preparation containing catechins at high concentrations, the product assumed a suspension state containing insoluble components. This suspension had a high viscosity and caused clogging of the spraying device.

The present invention is contemplated for providing a method for producing a catechins-rich cereal food excellent in quality. Furthermore, the present invention is contemplated for providing such catechins-rich cereal food excellent in quality.

The present inventor found that an aqueous catechin solution having a suppressed viscosity despite containing catechins at a sufficiently high concentration can be obtained, by using a specific purified preparation of a plant extract containing catechins. Furthermore, the present inventor found that a catechins-rich cereal food excellent in quality can be easily obtained by blending this aqueous solution in a formed cereal food.

The present invention relates to a method of producing a cereal food containing catechins in an amount of 0.1 mass % or more with respect to the dry mass of the cereal food, including spraying an aqueous solution of a purified preparation of a catechins-containing plant extract after forming a cereal food, the purified preparation of a catechins-containing plant extract having a turbidity of 30

FTU (formazin turbidity unit) or less at an aqueous solution of 0.5 mass % solid content.

Furthermore, the present invention relates to a cereal food containing catechins in an amount of 0.1 mass % or more with respect to the dry mass of the cereal food, wherein the cereal food is produced by blending a purified preparation of a catechins-containing plant extract therein, the purified preparation of a catechins-containing plant extract having a turbidity of 30 FTU (formazin) or less at an aqueous solution of 0.5 mass % solid content.

According to the present invention, a catechins-rich cereal food with a fine quality can be produced.

Other and further features and advantages of the invention will appear more fully from the following description.

### DETAILED DESCRIPTION OF THE INVENTION

In the present invention, the cereal food means a food that is generally referred to as a breakfast cereal (Ready to eat, Breakfast cereal) and is a food containing cereal grains formed by processing a food grain raw material obtained from food grains such as corn, rice, brown rice, wheat, barley, rye, oat, buckwheat, millet and Japanese millet by pressing, forming, swelling, baking and the like, and is generally eaten after adding a liquid food such as milk, and heating or not heating. Meanwhile, “baked confectionery” is present as similar foods in that they use a food grain as a raw material, but they are different from cereal foods in product category in that they are directly eaten, and they are not served as meals.

In the present invention, the term “catechins” means non-polymer catechins, and is a collective term for the collection of non-epi-form catechins such as catechin, gallocatechin, catechin gallate and gallocatechin gallate (GCg); and epi-form catechins such as epicatechin, epigallocatechin, epicatechin gallate and epigallocatechin gallate (EGCg).

A purified preparation of a catechins-containing plant extract used in the present invention (hereinafter referred to as “purified catechin preparation”) is obtained by further purifying an extract obtained from a catechins-containing plant. This purified preparation contains substances that are referred to as tannin that contains catechins, as well as polymerized products or hydrolysates thereof, and other flavonoids. It is preferable that the amount of tannin in the solid content of the purified catechin preparation is preferably 40 mass % (unless otherwise specified, mass % indicating content is hereinafter abbreviated to %) or more, more preferably from 40 to 99%, more preferably from 45 to 80%, more preferably from 50 to 70%, from the viewpoint that the amount of catechins required to exert physiological functions can be stably incorporated in the cereal. Furthermore, it is preferable that the amount of the catechins in the solid content of the purified catechin preparation is preferably 35% or more, more preferably from 40 to 90%, and more preferably from 45 to 80%, from the viewpoint that the amount of catechins required to exert physiological functions can be stably incorporated in the cereal food.

In the present invention, catechin gallate, gallocatechin gallate, epicatechin gallate and epigallocatechin gallate are collectively referred to as non-polymer catechin gallate forms. The purified catechin preparation of the present invention, preferably contains epigallocatechin gallate and/or an isomer thereof, and epicatechin gallate and/or an isomer thereof. The gallate form ratio in the catechins is a numerical value that is represented by the percentage of the total mass of these four kinds with respect to the total mass of the eight kinds of non-polymer catechins. Furthermore, the isomer of epigallocatechin gallate in the present invention is gallocatechin gallate, and the isomer of epicatechin gallate is catechin gallate.

In the present invention, the amount of the catechins in the cereal food is 0.1% or more with respect to the dry mass of the cereal food (i.e., 0.1% or more in the dried product of the cereal food), and is preferably from 0.2 to 10%, more preferably from 0.21 to 5%, more preferably from 0.25 to 3%, and more preferably from 0.25 to 1.7%, from the viewpoint of physiological effects. The dry mass of the cereal food means the mass of the cereal food after the cereal food is heated for 2 hours in a thermostat desiccator set to 105° C. and cooled in the desiccator until the temperature returns to room temperature.

In the present invention, the amount of catechins can be measured with high performance liquid chromatography under the conditions described in Examples, and the amount of tannin can be measured by an iron tartrate method under the conditions described in Examples by using ethyl gallate as a standard solution and based on the equivalent amount of gallic acid.

It is preferable that the purified catechin preparation used in the present invention is a solid, a powder form or a liquid form, and has a turbidity of 30 FTU (formazin) or less, more preferably 25 FTU (formazin) or less, and more preferably 10 FTU (formazin) or less at an aqueous solution of 0.5% solid content (a 0.5% aqueous solution), from the viewpoints that a cereal food stably containing catechins in an amount necessary to exert physiological functions can be obtained easily and stably, and the viscosity of the aqueous solution is low and clogging of the spray device is difficult to occur when the aqueous solution is sprayed, and thus the sprayability is fine. Furthermore, it is preferable that the purified catechin preparation has an absorbance at 671.5 nm of 0.3 or less, more preferably 0.25 or less, more preferably 0.15 or less at an aqueous solution of 1.0% solid content using a cell having an optical path length of 10 mm, from the viewpoints that a cereal food stably containing catechins in an amount necessary for expressing physiological functions can be obtained stably, and its viscosity is low and the sprayability be fine when the aqueous solution is sprayed.

Furthermore, it is preferable that the purified catechin preparation has a viscosity obtained with a type B viscometer at a temperature of 20° C. of preferably 200 mPa·s or less, more preferably from 5 to 160 mPa·s, more preferably from 10 to 60 mPa·s at an aqueous solution of 40% solid content, from the viewpoints that a cereal food stably containing catechins in an amount necessary to exert physiological functions can be obtained stably, and the sprayability be fine when the aqueous solution is sprayed.

It is preferable that the purified catechin preparation contains (A) myricetin, (B) quercetin and (C) kaempferol in the sum of their contents (the content of (A)+(B)+(C)) of from 0.000001 to 5%, more preferably from 0.00001 to 3%, more preferably from 0.001 to 1.75%, more preferably from 0.01 to 1.5%, from the viewpoints that the viscosity of the aqueous solution become low, and the sprayability is improved.

Furthermore, it is preferable that the purified catechin preparation contains (D) epigallocatechin gallate and (E) gallocatechin gallate in the sum of their contents (the content of (D)+(E)) of from 15 to 95%, more preferably from 18 to 40%, more preferably from 20 to 35%, from the viewpoints of the sprayability because of being low viscosity.

Furthermore, it is preferable that the ratio of the sum of the contents of (A) myricetin, (B) quercetin and (C) kaempferol to the sum of the contents of (D) epigallocatechin gallate and (E) gallocatechin gallate (the content of (A)+(B)+(C)/the content of (D)+(E)) is from 0.0001 to 0.1(mass ratio) from the viewpoints of the sprayability because of being low viscosity, and further, it is more preferable that the above ratio is from 0.001 to 0.09, and more preferably from 0.01 to 0.09. The contents of the components (A), (B), (C), (D) and (E) can be measured with high performance liquid chromatography under the conditions described in Examples, after the hydrolysis of the purified catechin preparation.

According to the present invention, a cereal food containing catechins in an amount of 0.1% or more with respect to the dry mass of the cereal food can also be produced by blending in a purified preparation of a catechins-containing plant extract, which has a turbidity of 30 FTU (formazin) or less at an aqueous solution of 0.5% solid content. In this case, it is preferable that, in the cereal food, the ratio of the sum of the contents of the above-mentioned components (A), (B) and (C) to the sum of the contents of (D) and (E) (the content of (A)+(B)+(C)/the content of (D)+(E)) is from 0.0001 to 0.1 (mass ratio) because a high-quality cereal food is formed. It is more preferable that the ratio is from 0.001 to 0.09, more preferably from 0.01 to 0.09.

Furthermore, it is preferable that the above-mentioned purified catechin preparation contains (F) rutin in an amount of from 0.0001 to 2%, more preferably from 0.001 to 1.2%, and more preferably from 0.01 to 1.0%, from the viewpoints of the sprayability because of being low viscosity. The content of the component (F) can be measured with high performance liquid chromatography under the conditions described in Examples. Rutin is one of flavonol glycosides, in which β-rutinose (6-O-α-L-rhamnosyl-D-β-glucose) is bound to the oxygen atom at the 3-position of quercetin.

It is preferable that the purified catechin preparation in the present invention contains caffeine in an amount of from 0.0001 to 10%, more preferably from 0.001 to 7%, more preferably from 0.01 to 5.5%, from the viewpoint of reduction of frequent urination, insomnia and the like which are caused by caffeine. The content of the caffeine can be measured with high performance liquid chromatography under the conditions described in Examples.

The purified catechin preparation used in the present invention may be one obtained by purifying a catechins-containing plant extract (hereinafter simply referred to as “plant extract”), and examples of the plant may include teas, grapes, apples, soybeans and the like. The teas include processed tea leaves such as green tea, oolong tea and black tea. Among them, green tea is specifically preferable. Here, for example, an extract from green tea refers to as “a green tea extract”.

Examples of the green tea extract may include a liquid extract obtained from green tea leaves. More specific examples of the above-mentioned processed tea leaves may include processed tea leaves obtained from Camellia such as C. sinensis, C. assamica, Yabukita species, hybrids thereof, and the like. Examples of the above-mentioned green tea may include ordinary tea (sencha), coarse tea (bancha), highest-quality tea (gyokuro), powdered green tea (tencha), roasted tea (kamairicha) and the like. Alternatively, tea leaves contacted with carbon dioxide in a supercritical state may also be used. As a means of obtaining an extract of tea, conventional methods such as extraction under stirring, a column method and drip extraction can be employed. Furthermore, an organic acid or an organic acid salt such as sodium ascorbate may be added in advance to the water for the extraction. Furthermore, a method of extracting under what is called a non-oxidative atmosphere while removing dissolved oxygen by deaeration by boiling or passing inert gas such as nitrogen gas may be employed in combination. A liquid extract obtained by these methods can be used directly or after drying and concentrating for the preparation of the purified catechin preparation used in the present invention. Examples of the form of the tea extract may include states of liquid, slurry, semi-solid and solid.

As the green tea extract, besides the liquid extract extracted from tea leaves, a concentrate of the green tea extract which is dissolved or diluted in water or an organic solvent may be used, or the liquid extract extracted from tea leaves and the dissolved or diluted solution of the concentrate of the green tea extract may be used in combination.

As used herein, the concentrate of the green tea extract is obtained by concentrating an extract extracted from green tea leaves with hot water or a water-soluble organic solvent, and for example, refers to those prepared by the methods described in JP-A-59-219384, JP-A-4-20589, JP-A-5-260907, JP-A-5-306279 and the like. Specifically, commercially available crude catechin preparations such as “POLYPHENONE” manufactured by Bussan Food Materials

Co., Ltd., “TEAFURAN” manufactured by Ito En, Ltd., “SUNPHENON” manufactured by Taiyo Kagaku Co., Ltd., and the like can be used as a solid concentrate of the green tea extract.

Furthermore, for the catechins-containing plant extracts other than the green tea extracts, those extracted by general means can be used.

The purified catechin preparation in the present invention can be prepared by contacting the plant extract such as the green tea extract directly or in a state that the extract is dispersed or dissolved in water or an organic solvent aqueous solution, with an active carbon, an acid clay and/or an active clay (hereinafter also referred to as “acid clay or the like”), a filtration aid or the like.

The order of contacting the plant extract with the active carbon, the acid clay or the like, and optionally the filtration aid or the like is not specifically limited. Examples may include (1) a method in which the plant extract is dispersed or dissolved in water or an organic solvent aqueous solution, followed by adding simultaneously the active carbon, the acid clay or the like and optionally the filtration aid or the like thereto to allow contact, (2) a method in which the active carbon, the acid clay or the like and optionally the filtration aid or the like are dispersed in water or an organic solvent aqueous solution, followed by adding the plant extract thereto to allow contact, (3) a method in which the plant extract, the acid clay or the like and optionally the filtration aid or the like dissolved or dispersed in water or an organic solvent aqueous solution to contact the plant extract with the acid clay and the like and optionally the filtration aid or the like in advance, followed by adding the active carbon thereto, and the like. Among the methods of (1) to (3), the method of (1) or (3) is preferable. In the methods of (1) to (3), it is preferable to insert a filtration step before transferring to the subsequent step.

In the contact treatment, it is preferable to conduct the treatment after adjusting the pH to the range of from 4 to 6 so as to obtain a purified catechin preparation in which non-polymer catechins have been extracted efficiently. In order to adjust the pH, an organic acid such as citric acid, lactic acid, tartaric acid, succinic acid and malic acid can be added so that the range of a mass ratio of the organic acid to the non-polymer catechins (organic acid/non-polymer catechins) be from 0.01 to 0.20.

The contact treatment may be conducted by any of a batch-type method, a continuous treatment with columns, or the like, and for example, contacting the plant extract with an active carbon can be conducted by a method such as a continuous treatment with active carbon columns. In general, a method in which powdery active carbon or the like is added, followed by stirring to selectively adsorb impurities and a filtrate from which the impurities have been removed by filtration treatment is obtained, a method in which impurities are adsorbed by a continuous treatment using columns filled with granular active carbon or the like, or the like is employed.

As the organic solvent used for the purification of the plant extract, a water-soluble organic solvent is preferable, and examples may include alcohols such as methanol and ethanol, ketones such as acetone, and esters such as ethyl acetate, and ethanol is specifically preferable with consideration for use in beverage and food products. Examples of the water may include ion exchanged water, tap water, natural water and the like, and ion exchanged water is specifically preferable from the viewpoint of taste.

The mixing mass ratio of the organic solvent to water (organic solvent/water) is preferably from 60/40 to 97/3, more preferably from 60/40 to 75/25, more preferably from 85/15 to 95/5, from the viewpoints of the extraction efficiency of the non-polymer catechins, the purification efficiency of the plant extract, and the like.

For the ratio of the plant extract to the water or the organic solvent aqueous solution, it is preferable to treat by adding from 10 to 40 parts by mass, more preferably from 10 to 30 parts by mass, more preferably from 15 to 30 parts by mass of the plant extract (dried mass basis) with respect to 100 parts by mass of the water or the organic solvent aqueous solution, since the plant extract can be treated efficiently.

It is preferable to provide an aging time of from about 10 to about 180 minutes to the contact treatment, and these treatments can be conducted at from 10 to 60° C., and are preferably conducted at from 10 to 50° C., more preferably from 10 to 40° C.

The active carbon used in the contact treatment is not specifically limited as long as it is generally used in an industrial level, and for example, commercially available products such as ZN-50 (manufactured by Hokuetsu Carbon Industry Co., Ltd.), KURARAYCOAL GLC, KURARAYCOAL PK-D and KURARAYCOAL PW-D (manufactured by Kuraray Chemical Co., Ltd.) and SHIRASAGI AW50, SHIRASAGI A, SHIRASAGI M and SHIRASAGI C (manufactured by Takeda Pharmaceutical Co., Ltd.) can be used.

The active carbon preferably has a pore volume of from 0.01 to 0.8 mL/g, more preferably from 0.1 to 0.8 mL/g. Furthermore, one having a specific surface area of from 800 to 1,600 m²/g is preferable, and from 900 to 1,500 m²/g is more preferable. These material values are values based on a nitrogen adsorption method.

It is preferable to add the active carbon in an amount of from 0.5 to 8 parts by mass, more preferably from 0.5 to 3 parts by mass, with respect to 100 parts by mass of the water or the organic solvent aqueous solution, from the viewpoints of the efficiency of removal of impurities, and a small cake resistance in the filtration step.

Both of the acid clay and the active clay used in the contact treatment contains SiO₂, Al₂O₃, Fe₂O₃, CaO, MgO and the like as general chemical components, and those having an SiO₂/Al₂O₃ ratio of from 3 to 12 by a molar ratio are preferable, and from 4 to 9 by a molar ratio are more preferable. Furthermore, those containing Fe₂O₃ in an amount of from 2 to 5% , CaO in an amount of from 0 to 1.5% and MgO in an amount of from 1 to 7% are preferable.

Active clay is obtained by treating naturally-produced acid clay (montmorillonite-based clay) with a mineral acid such as sulfuric acid, and is a compound having a porous structure having a large specific surface area and adsorption ability. It is known that a specific surface area is changed, decoloration ability is improved and physical properties are changed by further treating acid clay with an acid.

Although the specific surface area of the acid clay or the active clay differs depending on the degree of the acid treatment and the like, it is preferably from 50 to 350 m²/g, and one having a pH (5% suspension) of from 2.5 to 8 is preferable and from 3.6 to 7 is more preferable. For example, as the acid clay, commercially available products such as MIZUKA ACE #600 (trade name, manufactured by Mizusawa Industrial Chemicals, Ltd.) can be used. Furthermore, as the active clay, commercially available products such as GALLEON EARTH V2 (trade name, manufactured by Mizusawa Industrial Chemicals, Ltd.) can be used.

Furthermore, the ratio of the active carbon and the acid clay and the like is preferably from 1 to 10 to 1 of the active carbon by mass ratio, and it is preferable that active carbon:acid clay and/or active clay=from 1:1 to 1:6.

It is preferable to add the acid clay and the like in an amount of from 2.5 to 25 parts by mass, more preferably from 2.5 to 15 parts by mass with respect to 100 parts by mass of the water or the organic solvent aqueous solution. If the addition amount of the acid clay and the like is too small, the caffeine removal efficiency tends to decrease, whereas when the addition amount is too much, the cake resistance in the filtration step tends to increase.

The filtration aid used for the contact treatment is not specifically limited as long as it is a filtration aid that is generally used at an industrial level such as diatomaceous earth, and for example, commercially available products such as SOLKA-FLOC (trade name, manufactured by Imazu Chemical Co., Ltd.) and SILICA 100E-A (trade name, manufactured by Chuo Silica Co., Ltd.) can be used.

The temperature at which the active carbon and the like are separated from the water or organic solvent aqueous solution is preferably from −15 to 78° C., more preferably from 5 to 40° C. If the temperature is out of this range, the separation property may be poor, and a change may be observed in the characteristic of the solution.

As a method for the separation, a known technique can be employed, and for example, techniques such as filter separation and centrifuge, as well as separation by passing through a column filled with a granular substance such as an active carbon and the like may be used.

When further lowering of bitter taste is required, the plant extract can be treated with an enzyme having a tannase activity. Among those, a tannase is preferable. Examples may include tannases obtained by culturing tannase-producing bacteria belonging to genus Aspergillus, genus Penicillium or genus Rhizopus. Among these, one derived from Aspergillus oryzae is preferable.

Specifically, as the enzyme having a tannase activity, commercially available products such as PECTINASE PL AMANO (manufactured by Amano Enzyme, Inc.), HEMICELLULASE AMANO 90 (manufactured by Amano Enzyme, Inc.) and TANNASE KTFH (manufactured by Kikkoman Corporation) can be used. It is preferable to conduct a treatment with an enzyme having a tannase activity, i.e., an enzyme reaction, which is conducted in the present invention, with tannin acyl hydrase EC3.1.1.20 or the like. Examples of commercially available products may include a trade name “TANNASE” manufactured by Kikkoman Corporation, tannase “SANKYO” manufactured by Sankyo Co., Ltd. and the like.

It is preferable that the enzyme having a tannase activity has an enzyme activity of from 500 to 100,000 U/g, and when the enzyme activity is 500 U/g or less, a large amount of enzyme is required for treating within an industrially-limited time, whereas when the enzyme activity is 100,000 U/g or more, the enzyme reaction velocity is too fast and thus it becomes difficult to control the reaction system. Here, 1 Unit represents the amount of the enzyme at which 1 micromole of ester bonds included in tanninc acid is hydrolyzed in water at 30° C. Here, having a tannase activity means having an activity to decompose tannin, and any enzyme can be used as long as it has this activity.

The concentration of the non-polymer catechins for a treatment with the enzyme having a tannase activity is preferably from 0.1 to 22%, more preferably from 0.1 to 15%, more preferably from 0.5 to 10%, and more preferably from 0.5 to 3%.

The enzyme having a tannase activity is added so as to be preferably from 1 to 300 Unit, more preferably from 3 to 200 Unit, more preferably from 5 to 150 Unit with respect to 1 g of the non-polymer catechins in the plant extract.

The temperature of the enzyme treatment is preferably from 0 to 70° C. at which an optimal enzyme activity can be obtained, and is more preferably from 0 to 60° C., and more preferably from 5 to 50° C.

In order to terminate the enzyme reaction, the enzyme activity is deactivated. The temperature for the enzyme deactivation is preferably from 70 to 100° C., and the retention time therefor is preferably from 10 seconds to 20 minutes. If the deactivation temperature is too low, it is difficult to sufficiently deactivate the enzyme within a short time, and thus the reaction proceeds and the enzyme reaction cannot be stopped within a required range of the gallate form ratio of the non-polymer catechins. Furthermore, if the retention time after attaining a deactivation temperature is too short, it is difficult to sufficiently deactivate the enzyme activity, and thus the enzyme reaction proceeds. Whereas a too long retention time is not preferable since non-epimerization of the non-polymer catechins may occur.

As a means of deactivating the enzyme reaction, the reaction can be stopped by heating in a continuous manner such as a batch-type or plate-type heat exchanger. Furthermore, after the completion of the deactivation of the tannase treatment, the plant extract can be cleaned by an operation such as centrifugation.

As a means of blending the obtained purified catechin preparation in the cereal food, although the purified catechin preparation may be blended simultaneously with the cereal powder raw material, it is preferable that the catechins are incorporated after forming the cereal food, from the viewpoint that the lowering of the content of the catechins due to the heat during a steaming step, a baking step and the like can be prevented. Here, the forming of the cereal food includes steps of steaming, cooling, pressing, forming, swelling, drying and baking of a food grain raw material, and it is more preferable to blend the purified catechin preparation after completion of the baking step from the above-mentioned viewpoints. In the present invention, as a means of blending after forming the cereal food, a method in which preparing aqueous solution of the purified catechin preparation and this aqueous solution is sprayed on the formed cereal food is preferable from the viewpoints of quantitative performance and stability.

The means of spraying may includes dispersing or dissolving the purified catechin preparation in water, and spraying it on the surface of the formed cereal food by using a general spraying device. Examples may include a conveyor belt system in which spraying is conducted on the cereal food mounted on a conveyor belt, a rotation drum system in which spraying is conducted on the cereal food that transfers in a rotation drum, or the like. It is preferable to adjust the concentration of the catechins in the aqueous solution of the purified catechin preparation to from 1 to 50%, more preferably from 5 to 40%, more preferably from 9 to 35%, from the viewpoints of preventing the softening and aggregation of the cereal food, easiness of the drying after the spraying, and incorporating a large amount of catechins in the cereal food.

Furthermore, it is preferable that the sprayed amount of the catechin aqueous solution during the spraying treatment is adjusted to from 0.2 to 10 g, more preferably from 0.3 to 6 g, more preferably from 0.5 to 5 g, with respect to 100 g of the cereal food, from the viewpoints of preventing the softening and aggregation of the cereal food, easiness of the drying after the spraying, and incorporating a large amount of catechins in the cereal food. The sprayed amount of the aqueous solution with respect to 100 g of the cereal food is the attached amount of the catechin aqueous solution with respect to 100 g of the cereal food.

The form of the cereal food in the present invention is not specifically limited, and examples may include flaked cereal, puffed cereal, shredded cereal, extrude expand cereal, granola and granola-like foods, and the like. With regard to the method for producing the cereal food of the present invention, the cereal food can be produced according to a production method that is tailored to the form of the above-mentioned cereal food, except incorporating catechins. Namely, in order to produce the cereal food, it is sufficient to conduct steaming, cooling, pressing, forming, swelling, drying and baking and the like of a food grain raw material by conventional means.

The main raw material of the cereal food is various food grains, and there are two forms therefor: cereal grains and a cereal powder. The cereal grains are used directly, or used by mixing with the cereal powder. When the cereal grains and the cereal powder are mixed, or when only the cereal powder are used, they are formed into pellets (extrude pellets) by a cooking extruder.

Examples of the cereal grains as the raw material used in the present invention may include corn, brown rice, wheat, barley, rye, oat, adlay, naked barley, buckwheat, millet, proso millet, Japanese millet, milo and amaranth. Furthermore, beans such as soybean, red bean, green pea, fava bean and marrow bean are also included.

Although the raw material for the cereal food in the present invention may be only the above-mentioned cereal grains and the like, emulsifiers, binders, saccharides, natural or artificial sweeteners, chocolate, cocoa, dietary salt, seasonings, spices, fats and oils, colorants, dried vegetables, dried fruits, nuts, vitamins, mineral additives, dietary fibers, proteins and the like can be optionally blended. The means of blending in these additives is not specifically limited, and they may be kneaded into a dough or mixed together with the above-mentioned aqueous solution of the purified catechin preparation. Further, may be blended after spraying the aqueous solution of the purified catechin preparation.

Examples of the emulsifiers may include glycerin fatty acid esters, sucrose fatty acid esters, sorbitan fatty acid esters and the like. These emulsifiers have a function to prevent cereal grains from attaching to each other during a production.

Furthermore, friction is decreased during granulation by an extruder and the grains become difficult to be excessively broken, and attaching of granules to each other can be prevented after the granulation.

As the binders, starch, gums and thickening agents can be used, and it is sufficient to blend these by a small amount.

Examples of the fats and oils may include corn oil, sesame oil, soybean oil, wheat germ oil, palm oil, rapeseed oil, sunflower oil, cottonseed oil and the like.

The saccharides include monosaccharides, disaccharides and polysaccharides such as glucose, fructose, lactose, sucrose, maltose, xylose, ribose, mannose, sorbitol, dextrin, reduced dextrin and the like, and these are used with one kind or combination of two or more kinds. Alternatively, honey, maple sugar, starch syrup and the like can also be used in a similar manner.

As the natural or artificial sweeteners, for example, stevia, a sodium salt or calcium salt of saccharin, cyclamate, aspartame and the like can also be used in combination. The saccharides are used by a ratio of from 10 to 50 parts, preferably from 20 to 40 parts to 100 parts of flakes. This amount can be suitably increased according to the kind of the raw material food grain and the property of a final product to be obtained.

As the dried vegetables, carrot, spinach and the like can be used.

The dried fruits may include apple, raisin, strawberry, papaya and the like. Furthermore, nuts such as almond, pine nut and walnut, as well as cacaos such as cacao mass and cacao butter can be used.

Vitamins such as vitamin A, B-complex vitamins, vitamin C, vitamin D, vitamin E and niacin; minerals such as inorganic iron, heme iron, calcium, potassium, magnesium, zinc, copper, selenium, manganese, cobalt, iodine and phosphorus; dietary fibers such as indigestible dextrin, crystalline cellulose, apple fiber, wheat bran, rice bran, corn bran and wood fibers are used. The proteins may be plant proteins or animal proteins, and among the plant proteins, powders of soybean protein, powders of wheat protein and the like are preferable, and among the animal proteins, meat powder, milk casein and egg white powder are preferably used.

### EXAMPLES

### <Method for Measuring Non-Polymer Catechins>

The measurement of non-polymer catechins was conducted by diluting a catechin preparation (an extract of a catechins-containing plant or a purified preparation thereof) with distilled water and filtered by a filter (pore size: 0.8 μm), and thereafter conducting a gradient method using liquid A and liquid B, by using high performance liquid chromatography manufactured by Shimadzu Corporation (model SCL-10AVP) attaching a packed column for liquid chromatography in which octadecyl groups had been introduced, L-COLUMN TM ODS (4.6 mmφ×250 mm: manufactured by Chemicals Evaluation and Research Institute, Japan), at a column temperature of 35° C. The liquid A as a mobile phase, was a distilled water solution containing 0.1 mol/L of acetic acid, the liquid B was an acetonitrile solution containing 0.1 mol/L of acetic acid, and the measurement was conducted under the conditions of an injection amount of the sample of 20 μL and a UV detector wavelength of 280 nm.

### <Method for Measuring Tannin>

Tannin was measured by an iron tartrate method as an equivalent amount of gallic acid by using ethyl gallate as a standard solution. (Reference literature: “Green Tea Polyphenols”, Functional Material Effective Utilization Technology Series on Diet, No. 10.) Was 5 mL of the sample color-developed with 5 mL of an iron tartrate standard solution, the volume was adjusted to 25 mL with phosphate buffer, the absorbance was measured at 540 nm, and tannin was obtained from a calibration curve prepared by using ethyl gallate.

Preparation of iron tartrate standard solution: 100 mg of ferrous sulfate heptahydrate and 500 mg of sodium potassium tartrate were adjusted to 100 mL with distilled water.

Preparation of phosphate buffer: 1/15 mol/L disodium hydrogen phosphate solution and 1/15 mol/L sodium dihydrogen phosphate solution were mixed to adjust its pH to 7.5.

### <Method for Measuring Rutin>

A sample solution was filtered by a filter (0.45 μm), and analyzed by a gradient method by using high performance liquid chromatograph (model: Waters 2695, manufactured by WATERS) attaching a column (Shimpach VP ODS, 150×4.6 mm I.D.) at a column temperature of 40° C. Liquid A as a mobile phase was a distilled water aqueous solution containing 0.05% of phosphoric acid, and liquid B was a methanol solution, and the measurement was conducted under conditions of a flow rate of 1 mL/min, a sample injection amount of 10 μL and a UV detector wavelength of 368 nm. The conditions for the gradient are as follows.

| Time | Concentration of liquid A | Concentration of liquid B |
|---|---|---|
| (min) | (vol %) | (vol %) |
| 0.0 | 95 | 5 |
| 20.0 | 80 | 20 |
| 40.0 | 30 | 70 |
| 41.0 | 0 | 100 |
| 46.0 | 0 | 100 |
| 47.0 | 95 | 5 |
| 60.0 | 95 | 5 |

### <Measurement of Flavonols>

### (1) Hydrolysis of Sample

Were 200 μL of mercaptoethanol and 500 μL of 2N hydrochloric acid added to 5 mL of a sample solution.

Thereafter the sample was heated in a dry block bath (manufactured by

As One Corporation) at 120° C. for 40 minutes and cooled.

### (2) Analysis

The myricetin, quercetin and kaempferol that were present in the sample solution after the hydrolysis were quantified with high performance liquid chromatography. The quantification was conducted by a gradient method, and the analysis method was the same as that in the above-mentioned “Method for measuring rutin”.

### (3) Total Amount of Flavonols

Total amount of flavonols was obtained as the sum of the amounts of the myricetin, quercetin and kaempferol which were quantified by the above-mentioned analysis.

### <Method for Measuring Caffeine>

The following apparatus was used.

HPLC (manufactured by Hitachi, Ltd.)

Plotter: D-2500, detector: L-4200

Pump: L-7100, auto sampler: L-7200

Column: lnertsil ODS-2, inner diameter 2.1 mm×length 250 mm

The analysis conditions are as follows.

Injection amount of sample: 10 μL, flow amount: 1.0 mL/min

UV absorptiometer detection wavelength: 280 nm

Eluant A: aqueous solution containing acetic acid in an amount of 0.1 mol/L, eluant B: acetonitrile solution containing acetic acid in an amount of 0.1 mol/L

Conditions for concentration gradient (vol %)

| Time (min) | Eluant A | Eluant B |
|---|---|---|
| 0 | 97 | 3 |
| 5 | 97 | 3 |
| 37 | 80 | 20 |
| 43 | 80 | 20 |
| 43.5 | 0 | 100 |
| 48.5 | 0 | 100 |
| 49 | 97 | 3 |
| 62 | 97 | 3 |

The retention time of caffeine was 27.2 min.

The mass % was obtained from the area % obtained here.

### <Method for Measuring Moisture Ratio of Catechin Preparation>

Was 2 to 3 g of a catechin preparation weighed and put into a thermostat bath set to 105° C. for 2 hours. The difference between the masses before and after the putting into the bath was defined as a moisture content, and the percentage of the value obtained by dividing the moisture content by the mass of the catechin preparation before putting into the bath was considered as the moisture ratio of the catechin preparation.

### <Method for Measuring Solid Content>

Solid content was calculated by the following formula after weighing about 1 g of a sample, drying the sample at 105° C. for 3 hours or more and weighing.

Solid content=(mass after drying/mass before drying)×100

### <Method for Measuring Turbidity>

The measurement of the turbidity was conducted according to JIS K0400-9-10 (Water quality−Measurement of Turbidity). The measurement device was a haze-transmittance meter (HM-150, integrating-sphere type, manufactured by Murakami Color Research Laboratory, Ltd.), and an absorb cell of 10 mm was used. A formazin standard solution (400 FTU (formazin)) (manufactured by Kanto Kagaku) was diluted to prepare a [5 to 100 FTU (formazin)] calibration curve. The intensity of the scattered light (τd) and the intensity of the whole transmitted light (τt) in a sample prepared as an aqueous solution with 0.5% of a solid content were measured, τd/τt×100 was calculated, and the integrating-sphere turbidity [FTU (formazin)] of the sample was obtained from a calibration curve.

### <Method for Measuring Absorbance>

Using Hitachi Spectrophotometer (U-3310), the absorbance at 400 to 900 nm of an aqueous solution with 1.0% of a solid content of the sample was measured by using a dispocell having an optical path length of 10 mm (made of PMMA). The value at 671.5 nm at that time was defined as an absorbance (Abs).

### <Method for Measuring Viscosity>

In the viscosity measurement, a type B viscometer (20° C.) was used, and the average value of three times was defined as a measured value. The measurement sample was stirred in advance in a rotary stirrer for several hours to thereby dissolve sufficiently.

### <Preparation of Catechin Preparation>

Was 100 g of a caffeine-containing catechin composition (POLYPHENONE HG, manufactured by Tokyo Food Techno) suspended in 490.9 g of a 95% ethanol aqueous solution under stirring conditions of an ordinary temperature and 250 rpm, 20 g of active carbon (KURARAYCOAL GLC, trade name, manufactured by Kuraray Chemical Co., Ltd.) and 100 g of acid clay (MIZUKA ACE #600, trade name, manufactured by Mizusawa Industrial Chemicals, Ltd) were added thereto, and stirring was continued for about 10 minutes. Was 409.1 g of a 40% ethanol aqueous solution then added dropwise thereto over 10 minutes, and thereafter a stirring treatment for about 30 minutes was continued at room temperature. The active carbon and precipitated product were then filtered off by a filter paper No. 2, and thereafter filtration was conducted again by a 0.2 μm membrane filter. Finally, 200 g of ion exchanged water was added to the filtrate, ethanol was distilled off at 40° C. and 25 Torr, and this was lyophilized to give a powdery catechin preparation (i).

Catechin preparation (v) is POL-JK (pale green, manufactured by Mitsui Norin Co., Ltd.), and catechin preparation (vi) is POLYPHENONE 70A (red ocher, manufactured by Mitsui Norin Co., Ltd.).

Catechin preparations (ii) to (iv) were prepared by blending the catechin preparations (i) and (v). The values of the componential analysis are shown in Table 1.

TABLE 1

| Component content in | | | | | | | |
|---|---|---|---|---|---|---|---|
| catechin preparation | Unit | (i) | (ii) | (iii) | (iv) | (v) | (vi) |
| Non-polymer catechins | (%) | 64.1 | 55.1 | 46.0 | 40.0 | 34.0 | 77.4 |
| Tannin | (%) | 67.3 | 59.4 | 51.6 | 46.3 | 41.1 | 99.0 |
| Non-polymer catechins/Tannin | (mass ratio) | 0.95 | 0.91 | 0.88 | 0.85 | 0.83 | 0.78 |
| (D) + (E) | (%) | 26.70 | 22.92 | 19.14 | 16.62 | 14.10 | 60.46 |
| (F) Rutin | (%) | 0.73 | 0.89 | 1.05 | 1.15 | 1.26 | 1.03 |
| Caffeine | (%) | 4.06 | 4.62 | 5.16 | 5.56 | 5.93 | 0.20 |
| (A) + (B) + (C) | (%) | 1.04 | 1.79 | 1.54 | 1.71 | 1.88 | 1.52 |
| ((A) + (B) + (C))/((D) + (E)) | (mass ratio) | 0.0388 | 0.0780 | 0.0807 | 0.1030 | 0.1337 | 0.0252 |
| Moisture ratio | (%) | 3.2 | 4.3 | 5.4 | 6.1 | 6.8 | 3.5 |
| Turbidity at aqueous solution | (formazin) | <1 | 10 | 21 | 32 | 58 | 1 |
| of 0.5% solid content | | | | | | | |
| Absorbance (671.5 nm) at aqueous | (Abs) | 0.01 | 0.12 | 0.23 | 0.32 | 0.65 | 0.06 |
| solution of 1.0% solid content | | | | | | | |
| Viscosity at aqueous solution | (mPa · s) | 18 | 48 | 154 | 286 | 473 | 25 |
| of 40% solid content | | | | | | | |

(A) myricetin, (B) quercetin, (C) kaempferol, (D) epigallocatechin gallate, (E) gallocatechin gallate

The catechin preparations (i), (ii), (iii) and (vi) had a turbidity of 30 FTU (formazin) at an aqueous solution of 0.5% solid content, and specifically, the catechin preparation (i) showed a very low turbidity of 1 FTU (formazin) or less at an aqueous solution of 0.5% solid content. On the other hand, the catechin preparations (iv) and (v) had a turbidity of 30 FTU (formazin) or more at an aqueous solution of 0.5% solid content.

### Examples

### Production and Evaluation of Catechin-Containing Cereal Foods

The above-mentioned each catechin preparations (i) to (vi) was dissolved in ion-exchanged water to prepare an aqueous solution of the catechin preparation so as to have the solid content concentration shown in Table 2. This solution was filled in a pump-type spray container (manufactured by Nikko, PET-S (100 mL)). As a cereal food, a commercially available product of cornflakes (manufactured by Nissin Cisco Co., Ltd.) was used. Were 20.00 g of the cornflakes put into a polyethylene bag with a zipper (UNIPACK H-4, Seisannipponsha Ltd.), and the catechin aqueous solution was sprayed thereon by the pump-type spray container so that the cornflakes were uniformly wet.

The sprayability of the aqueous solution of the catechin preparation was evaluated according to the following criteria. The results are shown in Table 2.

### (1) Sprayability of Aqueous Solution of Catechin Preparation

3: The preparation can be sprayed in the form of a mist, and thus has fine sprayability.
2: Water droplets are generated, and thus the sprayability is slightly poor.
1: The preparation cannot be sprayed due to clogging by insoluble substances or a high viscosity.

Subsequently, after the above-mentioned spraying, the cornflakes were transferred to a disposable aluminum tray (ALUMIBAT No. 3, manufactured by As One Corporation) and weighed, the attached amount of the aqueous solution of the catechin preparation was obtained, and the amount of the catechins attached to the cornflakes was calculated from the concentration of the catechins in the aqueous solution of the catechin preparation. The cornflakes after the spraying were, together with the disposable aluminum tray, put into an oven that had been heated to 110° C. in advance for 15 minutes to thereby conduct heat drying.

The quality of the obtained cereal food was evaluated according to the following criteria. Furthermore, after the evaluation, the cereal food was heated for 2 hours in a thermostat dryer set to 105° C., the cereal food was cooled in a desiccator until the temperature thereof returned to room temperature and thereafter the mass of the cereal food was measured, and the content of the catechins with respect to the dry mass of the cereal food was calculated. The results are shown in Table 2.

### (2) Quality of Cereal Food

When the cereal food absorbs moisture and gets soft (pruned), the cereal food tends to attach to each other and aggregate after the drying. A part of the aggregated product is crushed during or after the drying to give a pulverized product. Therefore, a state in which the cereal food does not get soft before the drying and does not aggregate after the drying, and a pulverized product is not generated was considered as a high quality, and an evaluation was made from this viewpoint according to the following criteria.

### (State Before Drying)

3: Fine (not softened)
2: Slightly poor (softened to some extent)
1: Poor (softened)

### (Aggregation State After Drying)

3: Fine (cereal food does not aggregate)
2: Slightly poor (cereal food aggregates to some extent)
1: Poor (cereal food aggregates)

### (Amount of Pulverized Product After Drying)

3: Fine (the amount of the pulverized product is little)
2: Slightly poor (the amount of the pulverized product is slightly much)
1: Poor (the amount of the pulverized product is much)

TABLE 2

| | | Examples | | | | | | | | | Comparative examples | | | |
|---|---|---|---|---|---|---|---|---|---|---|---|---|---|---|
| | | 1 | 2 | 3 | 4 | 5 | 6 | 7 | 8 | 9 | 1 | 2 | 3 | 4 |
| Catechin preparation | | (i) | (i) | (i) | (i) | (i) | (i) | (ii) | (iii) | (vi) | (v) | (iv) | (v) | (v) |
| Aqueous solution of | Solid content (mass %) | 40 | 40 | 40 | 40 | 40 | 15 | 40 | 40 | 40 | 40 | 40 | 5 | 50 |
| catechin preparation | Catechin concentration | 25.6 | 25.6 | 25.6 | 25.6 | 25.6 | 9.6 | 22.0 | 18.4 | 31.0 | 13.6 | 16.0 | 1.7 | 17.0 |
| | (mass %) | | | | | | | | | | | | | |

| Amount of aqueous catechin solution (g) | | 4.1 | 5.1 | 6.2 | 7.0 | 1.8 | 0.9 | 4.7 | 5.6 | 5.4 | 7.6 | 5.9 | 1.5 | — |
|---|---|---|---|---|---|---|---|---|---|---|---|---|---|---|
| attached to 100 g of cereal food | | | | | | | | | | | | | | |
| Amount of catechin (%) with respect to | | 1.0 | 1.3 | 1.6 | 1.8 | 0.5 | 0.1 | 1.0 | 1.0 | 1.7 | 1.0 | 0.9 | 0.03 | — |
| dry mass of cereal food. | | | | | | | | | | | | | | |
| Evaluation | Sprayability | 3 | 3 | 3 | 3 | 3 | 3 | 2 | 2 | 2 | 2 | 2 | 2 | 1 |
| | State before drying | 3 | 3 | 3 | 2 | 3 | 3 | 3 | 3 | 3 | 1 | 1 | 3 | — |
| | Aggregation state after drying | 3 | 3 | 3 | 2 | 3 | 3 | 3 | 3 | 3 | 1 | 2 | 3 | — |
| | Amount of pulverized product | 3 | 3 | 3 | 2 | 3 | 3 | 3 | 3 | 3 | 1 | 2 | 3 | — |
| | after drying | | | | | | | | | | | | | |

From the results in Table 2, when the catechin preparation (i) was used, the sprayability was fine even though the solid content was present at a high concentration of 40%. Furthermore, in the cases when the catechin preparations (ii) to (iv) were used, a solid content of 40% resulted in poor sprayability, but spraying itself was possible. In addition, in the aqueous solution with 50% of a solid content using the catechin preparation (v), the viscosity was high and the spraying machine was clogged, and thus spraying was impossible.

Furthermore, when the catechin preparation (i), (ii), (iii) or (vi) was used, the cornflakes were difficult to be soften, difficult to cause aggregation even after the drying, and a pulverized product was produced little, even though the aqueous solution containing the preparation at a high concentration as a solid content of 40% was sprayed thereon.

On the other hand, when the catechin preparation (v) or (iv) having a turbidity of 30 FTU (formazin) or more at an aqueous solution of 0.5% solid content was sprayed as an aqueous solution with 40% solid content, the cornflakes were significantly soften, the cereal food aggregated after the drying, and a pulverized product was generated much.

From the above-mentioned results, it was found that a catechins-rich cereal food excellent in quality can be produced by blending in the catechin purified preparation as defined in the present invention.

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2010-210900 filed in Japan on Sep. 21, 2010, which is entirely herein incorporated by reference.

1. A method of producing a cereal food,
comprising spraying an aqueous solution of a purified preparation of a catechin-comprising plant extract after forming a cereal food,
wherein
the aqueous solution of the purified preparation of a catechin-comprising plant extract comprises catechins in an amount of from 1 to 50 mass %,
the purified preparation of a catechin-comprising plant extract has a turbidity of 30 FTU (formazin) or less at an aqueous solution of 0.5 mass % solid content, and
the cereal food comprises catechins in an amount of 0.1 mass % or more with respect to the dry mass of the cereal food.

2. (canceled)

3. The method of producing a cereal food according to claim 1, wherein the sprayed amount of the aqueous solution of the purified preparation of a catechin-comprising plant extract is from 0.2 to 10 g with respect to 100 g of the cereal food.

4. The method of producing a cereal food according to claim 1, wherein the purified preparation of a catechin-comprising plant extract has an absorbance at 671.5 nm of 0.3 or less at an aqueous solution of 1.0 mass % solid content.

5. The method of producing a cereal food according to claim 1, wherein the purified preparation of a catechin-comprising plant extract has a viscosity at 20° C. of 200 mpa·s or less at an aqueous solution of 40 mass % solid content.

6. A cereal food, comprising:
catechins in an amount of 0.1 mass % or more with respect to the dry mass of the cereal food, wherein
the cereal food is produced by blending a purified preparation of a catechins-containing plant extract therein, the purified preparation of a catechin-comprising plant extract having a turbidity of 30 FTU (formazin) or less at an aqueous solution of 0.5 mass % solid content, and
the cereal food comprises (A) myricetin, (B) quercetin, (C) kaempferol, (D) epigallocatechin gallate and (E) gallocatechin gallate where the ratio of the sum of the contents of (A), (B) and (C) to the sum of the contents of (D) and (E) (the content of (A)+(B)+(C)/the content of (D)+(E)) be from 0.01 to 0.09 (mass ratio).

7. (canceled)

8. The method of producing a cereal food according to claim 1, wherein the purified preparation of a catechin-comprising plant extract comprises (A) myricetin, (B) quercetin, (C) kaempferol, (D) epigallocatechin gallate and (E) gallocatechin gallate where the ratio of the sum of the contents of (A), (B) and (C) to the sum of the contents of (D) and (E) (the content of (A)+(B)+(C)/the content of (D)+(E)) be from 0.0001 to 0.1 (mass ratio).

9. The method of producing a cereal food according to claim 8, wherein the ratio of the sum of the contents of (A), (B) and (C) to the sum of the contents of (D) and (E) (the content of (A)+(B)+(C)/the content of (D)+(E)) in the purified preparation of a catechin-comprising plant extract is from 0.01 to 0.09 (mass ratio).

10. The method of producing a cereal food according to claim 1, wherein the aqueous solution of the purified preparation of a catechin-comprising plant extract is sprayed on the formed cereal food mounted on a conveyor belt.

11. The method of producing a cereal food according to claim 1, wherein the aqueous solution of the purified preparation of a catechin-comprising plant extract is sprayed on the formed cereal food that transfers in a rotation drum.

12. The cereal food according to claim 6, wherein the cereal food is produced by spraying an aqueous solution of the purified preparation of a catechin-comprising plant extract on a formed cereal food, the aqueous solution of the purified preparation of a catechin-comprising plant extract comprising catechins in an amount of from 1 to 50 mass %, the purified preparation of a catechin-comprising plant extract having a turbidity of 30 FTU (formazin) or less at an aqueous solution of 0.5 mass % solid content.

13. The cereal food according to claim 6, wherein the purified preparation of a catechin-comprising plant extract is derived from at least one kind of plant selected from the group consisting of tea, grape, apple and soybean.

14. The cereal food according to claim 6, wherein the amount of tannin in the solid content of the purified preparation of a catechin-comprising plant extract is 40 mass % or more.

15. The cereal food according to claim 6, wherein the amount of rutin in the solid content of the purified preparation of a catechin-comprising plant extract is from 0.0001 to 2 mass %.

16. The cereal food according to claim 6, wherein the amount of caffeine in the solid content of the purified preparation of a catechin-comprising plant extract is from 0.0001 to 10 mass %.

17. The cereal food according to claim 6, wherein the purified preparation of a catechin-comprising plant extract is prepared by contacting a green tea extract with an active carbon, and an acid clay and/or active clay.
